(19) United States
(12) Patent Application Publication
(10) Pub. No.: US 2007/0000826 A1
(43) Pub. Date: Jan. 4, 2007

(54) MEMBRANE PRESS

(76) Inventor: Hans-Gerd Stevens, Bocholt (DE)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/427,428

(22) Filed: Jun. 29, 2006

(30) Foreign Application Priority Data
Jul. 4, 2005 (DE) 102005031416.3

(51) Int. Cl. B01D 29/00

(52) U.S. Cl. 210/153

(57) ABSTRACT

A membrane press including at least one holding frame, wherein a membrane is, at its peripheral region, located on and removed from the holding frame by holding elements, wherein the holding elements are designed such that the membrane is located thereon and removed therefrom without any tools. A first membrane press has holding elements designed with two clamping surfaces in the manner of a claw, wherein a clamping bolt is assigned to the clamping surfaces so that the membrane is located in a force-locking manner, wherein the membrane is clamped between the clamping bolt and one of the clamping surfaces. A second membrane press includes a holding element designed in a buckle-like manner in the form of one of a buckle lock, a clamping lock, a spring clip, a sliding web lock, an eccentric lock and a belt clamp.

### BACKGROUND OF THE INVENTION

The present invention relates to a membrane press comprising at least one holding frame, wherein a membrane can, at its peripheral region, be located on and removed from the holding frame by means of holding elements, wherein the holding elements are designed such that the membrane can be located thereon and removed therefrom without any tools.

Such membrane presses, in particular laminators, are known in the art.

DE 30 17 273 discloses a membrane molding press with a pressure chamber that is open towards one side, comprising a membrane loosely covering the open side of the pressure chamber while the press is open, the membrane being located on the outside of the pressure chamber. The membrane molding press comprises a counter plate positioned opposite to the open side of the pressure chamber and a drive for placing the counter plate and the pressure chamber adjacent to each other in a force-locking manner. Furthermore, the membrane press comprises a device for applying a pressurized flow medium to the working chamber that is limited by the membrane and the pressure chamber while the press is closed. On its outside, the pressure chamber carries a membrane clamping device engaging the membrane.

DE 38 27 497 A1 relates to an apparatus for coating three-dimensional bodies with a foil, comprising a table for receiving the body to be coated, a pressure cushion that can be lowered onto the body and contains a membrane which is held in a box-shaped open-bottom carrier and a clamping frame for clamping the foil, the clamping frame being arranged underneath the membrane and following the contour of the body while being spaced apart therefrom. The box-shaped carrier consists of a heatable base plate and a holding frame that can be moved in a vertical direction in relation to the base plate and that holds the membrane.

DE 103 23 772 B3 discloses a method and an apparatus for three-dimensional coating of flat workpieces with residual foils. The apparatus consists of a press with press tables, one each at bottom and top, as well as of a lower frame and an upper frame, wherein the lower frame is divided by an inserted divider strip to form a working frame and a residual frame and the upper frame is arranged above the residual foil over the working frame. A cover membrane rests upon each of the edges of the residual frame and upon the lower frame. The upper frame holds the residual foil and the cover membrane firmly secured. The cover membrane which can be inserted between the press tables as far as beyond the divider strip and is designed such that it forms an overlap with the free edge of the residual foil is arranged at the sides of the press tables. Thereabove, a movable strip which divides the upper frame and covers, holds and seals the overlap is arranged while the cover membrane is in its inserted state.

Hence, membrane holders are known, where the membrane, at its circumferential edge, is continuously clamped in behind clamping strips which are, for example, located by means of screws. Since the membrane must be exchanged relatively often during operation of membrane presses or laminators, this is disadvantageous in that comprehensive assembly work taking relatively long time is required, because an accordingly high number of screwed connections must be disconnected and resecured secured after the old membrane has been removed and the new membrane has been inserted. In practice, such an exchange must be made approximately every two weeks.

But there are also membrane presses which comprise heating panels supporting components, for example parts of furniture, to be laminated and resting thereupon. Thereabove, a membrane is arranged the edges of which are fixed through clamping strips and by means of screw clamps. At their rear, the clamping strips comprise angled sections extending in backward and downward direction and used to hang the clamping strips over the holding frame. The holding frame can be moved in vertical direction in order to tension the membrane for operation of the membrane press and for membrane replacement. The membrane, however, is disadvantageous in that it must be assembled outside of the membrane press by attaching the clamping strips to the membrane beforehand. Thereafter, the membrane must be inserted in the membrane press, including the clamping strips attached to the four sides of the membrane. This is relatively difficult because the surfaces concerned are large and the membrane and the clamping strips are relatively heavy.

The known state of the art is, furthermore, disadvantageous in that the membrane comprises holes at its edge, for example for passing the screws through the holes. These holes, however, weaken the membrane edge, with the result that the holes are a frequent starting point of cracks which might completely destroy the membrane.

### SUMMARY OF THE INVENTION

The invention aims at improving a membrane press of the aforementioned type such that a long service life of the membrane is achieved and that the membrane can be replaced in such an easy manner that the time saved is considerable.

The embodiment according to the invention of the holding elements is advantageuos in that, on due membrane replacement which must, in practice, usually be carried out approximately every two weeks or on an initial insertion of the membrane in the membrane press, the membrane can be manually removed from the holding elements without any tools and can also be located again without the use of any additional tool. To be located, the membrane can initially be inserted in the membrane press without the holding elements according to the invention. Thereafter, a single operator can then very quickly bring the holding elements, one after the other, in engagement with the membrane edge without using any tools. As a result, the time saved is considerable wherein, surprisingly, the membrane replacement with the holding elements according to the invention has turned out to take only about a quarter of the time required for a conventional holder with a plurality of screws which must be unscrewed and/or tightened by means of additional tools, for example by means of a wrench.

A first further development of the membrane provides that the holding elements comprise a transverse web with a clamping web arranged on either of its sides wherein, as seen in cross-section, the clamping webs are aligned such that they are facing away from the transverse web with their free end and are extending in a direction towards each other at a slanted angle, with the result that an opening which increases in the direction of the transverse web in a cone-like manner is formed opposite to the transverse web, wherein the clamping bolt is arranged in a clamping position near the free ends between the membrane and a locating surface positioned opposite to the clamping surface so that the membrane is located in a force-locking manner, and wherein the clamping bolt can be lifted from the clamping position in the direction to the transverse web, with the result that the membrane is detached.

An alternative embodiment provides that the holding elements comprise a transverse web which, on one of its sides, is immediately and rigidly connected to the holding frame and at the other side of which a clamping web is arranged, wherein, as seen in cross-section, the clamping web is aligned such that it is facing away from the transverse web with its free end and is, at a slanted angle, extending in a direction towards a clamping surface of the holding frame that faces the clamping web, with the result that an opening which increases in the direction of the transverse web in a cone-like manner is formed opposite to the transverse web, wherein the clamping bolt is arranged in a clamping position near the free end between the membrane and a locating surface positioned opposite to the clamping surface so that the membrane is located in a force-locking manner, and wherein the clamping bolt can be lifted from the clamping position in the direction to the transverse web, with the result that the membrane is detached.

In the two advantageous embodiments mentioned above, the membrane can, with its edge, be easily inserted through the opening in the holding element according to the invention, wherein the clamping bolt is lifted either manually by an operator or merely by inserting the membrane edge. Once the membrane has been inserted in the holding element with its edge to a sufficient extent, the operator can release the clamping bolt so that the latter comes to bear against one of the clamping webs between the membrane and the locating surface. As a result, the membrane is, in a force-locking manner, located on the clamping surface of the clamping web positioned opposite thereto through a self-clamping effect of the clamping bolt. Herein, the operator can connect the holding elements to the membrane edge one after the other, inasmuch as the holding elements are arranged such that they are distributed at intervals along the perimeter of the membrane wherein, according to a preferred executive form, the holding elements are in localized engagement. If the holding frame is moved in a clamping direction, the clamping bolt continues to move towards the opening, with the result that the membrane is sufficiently securely held by the holding element in a force-locking manner, wherein the self-clamping effect of the clamping bolt is increased.

To remove the membrane from the holding element according to the invention, the holding frame is moved in the opposite direction so that the membrane is relaxed. Thereafter, the operator can now easily lift the particular clamping bolts out of their clamping position one after the other in the direction of the transverse web, with the result that the membrane can be easily removed from each holding element without using any additional tool. While the membrane is in its relaxed position, the clamping bolt may, therein, occasionally be located such that the clamping bolt must, for example, be disconnected by gently hitting it. However, this does not change the fact that the time saved during replacement of the membrane is considerable, since gently hitting the clamping bolt does not take as much time as turning screws to unscrew them.

Where executive forms of certain embodiments of the membrane press are concerned, it is appropriate that the membrane edge is designed with teeth or indentation, wherein the individual teeth or indentations are matching the buckle-type holding element. Herein, the operator just has to insert the membrane edge or its teeth or indentations in the buckle or buckle-type element to achieve a force-locking connection.

All embodiments of the holding elements according to the invention are advantageous in that the membrane does not have to be provided with holes at its edge, with the result that the membrane is prevented from being destroyed, wherein such a destruction can, for example, be caused by cracks starting from the holes.

In order to ensure that the membrane is secured in a sufficiently uniform manner, it is appropriate according to the invention to provide the holding elements such that they engage the membrane while being distributed along the perimeter of the peripheral region, thus more or less forming a row of holding elements. As a matter of course, the holding elements can also engage the peripheral region of the membrane in a continuous manner. To achieve this, the holding frame can, at its perimeter, either be designed continuously or divided in sections.

In order to ensure that the holding elements are flexible at least for connecting the membrane to the holding elements, it is, in some embodiments, preferably provided that suspension elements which are arranged between the holding elements and the holding frame are assigned to the holding elements. This is advantageous in that, when the membrane is in its relaxed position, the holding elements are not rigidly connected to the holding frame but can be moved in three dimensions, with the result that an even easier connection to or insertion of the membrane in the holding elements according to the invention can be achieved.

Alternatively or additionally, spring elements which are arranged between the holding element and the holding frame can be assigned to the holding elements. As a result, the clamping force is introduced in the membrane in a particularly uniform manner, as seen along the perimeter of the membrane. For example, the spring elements are designed as coil springs.

In order to ensure that the membrane can be functioning effectively, the membrane must be clamped in its working position such that it forms a smooth surface, so that a sufficiently good production result of the membrane press or laminator can be obtained. For that reason, it is appropriately provided according to the invention that at least one adjusting device which can be used to adjust the holding frame in the clamping direction is assigned to the holding frame. As a result, the holding frame can be moved out of a relaxed position where the membrane can be easily connected to the holding elements to a clamped position where the membrane is tightened across its surface.

According to a simple design, it is favorable to have an adjusting device that can be actuated manually, wherein the adjusting device can, for example, be designed as a spindle.

As an alternative, however, it is also appropriate to have an adjusting device which comprises a power drive, wherein the adjusting device is, for example, designed as a hydraulic or pneumatic cylinder. Electric adjusting devices are also conceivable.

As regards the executive forms with adjusting device, it is furthermore suggested that the adjusting device can be used to apply a predefinable tensile stress to the membrane so that the membrane can be re-tensioned continuously. Therein, membrane elongations, which may, in practice, occur in the course of time or due to high temperatures, can be compensated automatically, thus always ensuring a desired smooth position of the membrane. If the adjusting device is, for example, designed as a pneumatic cylinder for lifting the holding frame, a tension that can be defined by a predefinable pneumatic pressure can be applied in clamping direction to the adjusting device, thus continuously re-tensioning the membrane.

To facilitate connection of the peripheral region of the membrane to the particular holding elements, it is preferably provided that the suspension elements are preferably mounted such that they can be moved in a longitudinal direction of the holding frame, in particular with their screw bolt. To achieve this, a longitudinal slot is preferably provided on the bottom side of the holding frame, wherein the suspension elements can, for example, be inserted in the longitudinal slot through open front faces of the holding frame. In order to adjust the screw bolt and mount it in the holding frame in a manner ensuring sufficient tensile strength, the screw bolt comprises at its head a nut to which a washer can be allocated.

In one embodiment, the peripheral region of the membrane can, for example, be tensioned over the edges of a plate or a frame in a vertical direction in relation to a horizontal plane, resulting in a vertical clamping direction. To save the membrane, the edges are appropriately rounded off.

To reduce frictional effects, the peripheral region of the membrane can, optionally, be clampable at an acute angle (0<α<90°) in relation to the horizontal plane, resulting in a clamping direction extending at an accordingly slanted angle.

Finally, the peripheral region of the membrane can, optionally, be clampable in parallel to the horizontal plane as seen in relation thereto, thereby preventing the membrane from being subject to harmful frictional effects.

Furthermore, the invention suggests for the membrane press that a membrane support in the form of a frame or plate is arranged immediately above the membrane, that a peripheral surrounding sealing frame is arranged below the membrane, that the distance of the membrane support including membrane on the one hand in relation to the sealing frame on the other hand can be adjusted, and that the membrane support and the sealing frame can be clamped against each other in a clamping position. In this manner, it is possible to fix the membrane support including membrane on the one hand and the bearing plate on the other hand in relation to each other with clamping the membrane. For a re-tensioning or for an exchange of the membrane the membrane support and the sealing frame are moved from their clamping position away from each other.

In a further development, a plurality of vertical clamping rods are provided for clamping the membrane support and the sealing frame against each other, wherein the clamping rods are arranged such that they are distributed along the perimeter of the membrane press, that, with their lower end, they can be brought in detachable engagement with hooks provided on the sealing frame, that they can be adjusted in vertical direction by means of a clamping lever provided at each of their upper ends, and that they can be located in a clamping position. This allows to achieve a simple yet reliable construction and easy operability.

All in all, the various advantageous embodiments of the invention, thus, provide an improved membrane press wherein the membrane can be removed and located without any tools. As a result, the usual membrane replacement which must, for example for a laminator, in practice be carried out approximately every two weeks, takes an essentially shorter time wherein, surprisingly, the membrane replacement with the holding elements described above has turned out to take only about a quarter of the time required for a conventional membrane holder with a plurality of screws.

### BRIEF DESCRIPTION OF THE DRAWINGS

Further advantageous embodiments are disclosed in the subordinate claims and in the description of figures following below. In the figures,

FIG. 1 is a cross-sectional view of a membrane press;

FIG. 2 is a lateral view of a detail of FIG. 1 with a spindle;

FIG. 3 is a lateral view of a detail of FIG. 1 with a cylinder;

FIG. 4 is a cross-sectional view of a membrane press with intermediately positioned spring elements;

FIG. 5 is a lateral view of a detail of a double membrane press with a spindle;

FIG. 6 is a lateral view of a detail of a double membrane press with a cylinder;

FIG. 7 is a lateral view of a double membrane press with two spindles;

FIG. 8 is a lateral view of a double membrane press with two cylinders;

FIG. 9 is a perspective view of a holding frame of a membrane press with integrated holding elements, at a slanted angle from above;

FIG. 10 is a cross-sectional view of a peripheral region of the membrane press with holding frame according to FIG. 9;

FIG. 11 is a lateral view of a membrane press or laminator with a spindle and a further holding element;

FIG. 12 is a lateral view of a membrane press or laminator with the holding element of FIG. 11 and a cylinder; and

FIG. 13 is a view of the membrane when clamped horizontally.

Identical parts in the various figures are always identified by the same reference numbers so that, as a rule, they are described only once.

### DETAILED DESCRIPTION OF THE PREFERRED EMBODIMENTS

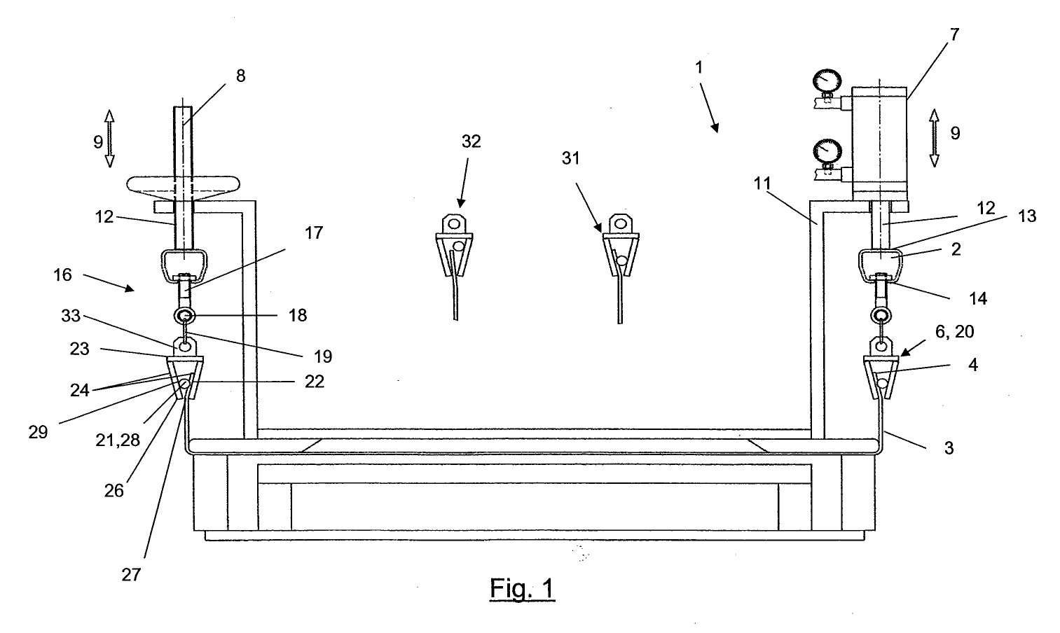

FIG. 1 shows a membrane press 1 comprising a holding frame 2. With its peripheral region 4, a membrane 3 can be located on and removed from the holding frame 2 via holding elements 6. The holding elements 6 are designed such that the membrane 3 can be removed and located without any tools.

The holding frame 2 is connected to adjusting devices 7, 8 such that the holding frame 2 can be adjusted in a clamping direction (double arrow 9).

For example, the adjusting devices 7, 8 can be designed as a pneumatic cylinder 7 or as a spindle 8. The exemplary embodiment illustrated in FIG. 1 shows both types of adjusting devices 7, 8, that is, on the one hand, the manually activated spindle and, on the other hand, the adjusting device 7 with a power drive (pneumatic cylinder). As a matter of course, it is also possible to use adjusting devices 7, 8 of the same kind in each case.

The adjusting devices 7, 8 are mounted to a rigid component 11 of the membrane press 1 or laminator in the usual manner, so that an active rod 12, which is designed either as a piston rod or as a spindle rod, is connected to a surface 13 of the holding frame 2 that is directed towards the active rod 12.

The holding frame 2 is designed as a hollow component. Suspension elements 16 comprising a screw bolt 17 which is, at its head, screwed to the holding frame 2 or is guided such that it can be moved in the holding frame 2 in the latter's longitudinal direction are arranged at a bottom side 14 of the holding frame 2 that is positioned opposite to the surface 13. At its foot, each suspension element 16 comprises an eyelet 18 which is, preferably, screwed to the screw bolt 17. A ring element 19 is arranged in the eyelet 18. The ring element 19 is connected to the holding element 6.

In the exemplary embodiment shown in FIG. 1, the holding element 6 is designed as a claw 20. Allocated to the holding element 6 is a clamping bolt 21 so that the membrane 3 can be located in a force-locking manner, wherein the membrane 3 is clamped between the clamping bolt 21 and a clamping surface 22.

The holding element 6 according to the exemplary embodiment shown in FIG. 1 comprises a transverse web 23 with a clamping web 24 arranged on either of its sides. As seen in cross-section, the clamping webs 24 are aligned such that they are facing away from the transverse web 23 with their free end 26 and are extending in a direction towards each other at a slanted angle, with the result that an opening 27 is formed opposite to the transverse web 23. The opening 27 increases in the direction of the transverse web 23 in a cone-like manner. The clamping bolt 21 is arranged in a clamping position 28 near the free ends 26 between the membrane 3 and a locating surface 29 that is positioned opposite to the clamping surface 22 so that the membrane 3 is located in a force-locking manner. The clamping bolt 21 can be lifted from the clamping position 28 in the direction of the transverse web 23, with the result that the membrane 3 is detached. In FIG. 1, this is shown by two separately drawn holding elements with reference numbers 31 and 32, wherein reference number 31 is assigned to a clamping position 28 of the clamping bolt and reference number 32 shows the clamping bolt while the latter is in its detached position, being lifted from the clamping position 28.

To connect the holding element 6 to the particular suspension elements 16, a perforated tab 33 is assigned to the transverse web 23, wherein the ring element 19 can be passed through the perforated tab 33 such that the ring element 19 is, on the one hand, suspended in the eyelet 18 and, on the other hand, in the perforated tab 33.

The holding frame 2 can be designed as a circumferential holding frame or as a holding frame that is subdivided in sections.

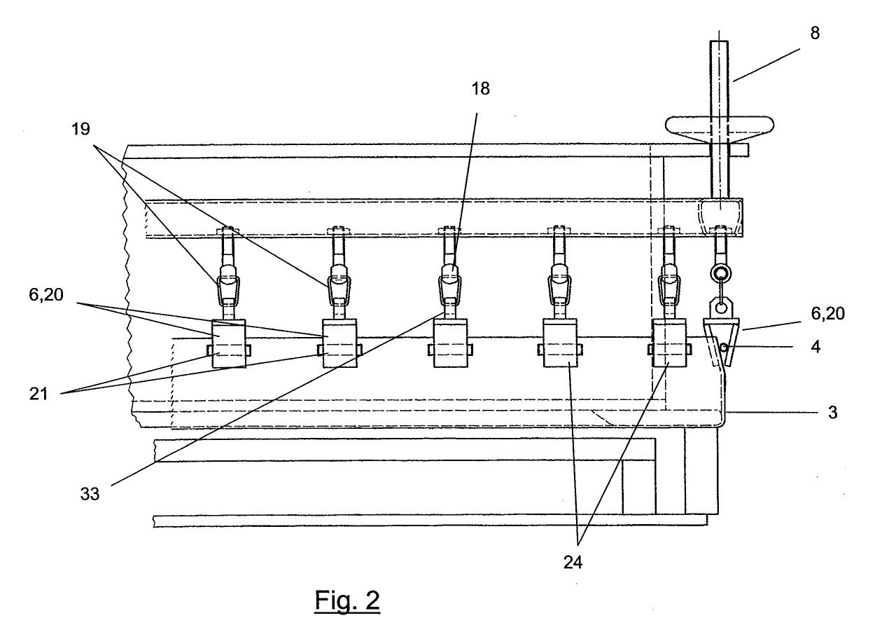

FIG. 2 is a lateral view of the membrane press 1, showing that the holding elements 6 engage the membrane 3 while being distributed along the perimeter of the peripheral region 4 of the membrane 3, so that the holding elements 6 are in localized engagement with the membrane 3, thus more or less forming a row of holding elements. Furthermore, FIG. 2 shows that the clamping bolts 21 each laterally project beyond the clamping webs 24 to a little extent. This fact of the clamping bolts 21 each laterally projecting beyond the clamping webs 24 to a little extent allows an operator to easily seize the clamping bolt 21 by hand, so that the clamping bolt 21 can be moved from its clamping position 28 to its detached position in the direction of the transverse web 23 easily and without any tools. The clamping bolt 21 causes a self-clamping effect, wherein the membrane 3 is sufficiently clamped in the holding element 6 according to the invention by being pulled, that is tensioned by means of the adjusting devices 7, 8.

Furthermore, FIG. 2 shows that, as seen from a lateral view, the ring elements 19 are designed conically such that, starting from the perforated tab 33, they slightly expand in the direction of the eyelet 18.

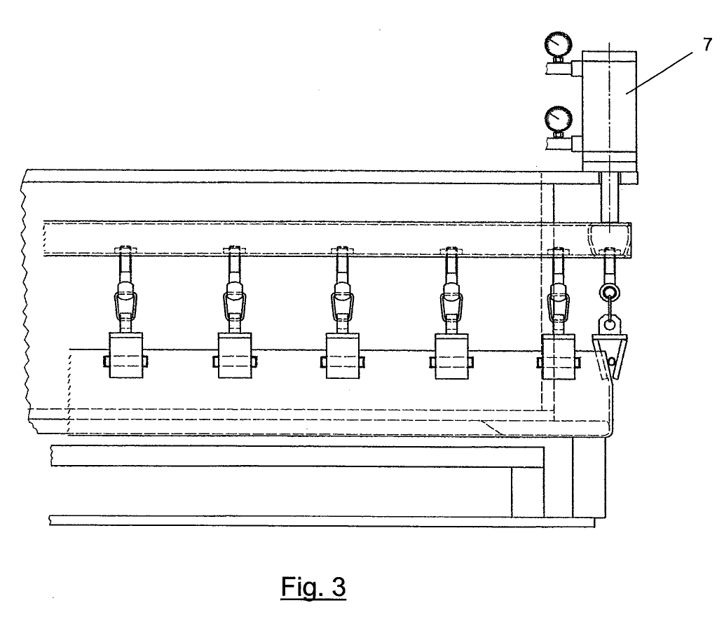

In FIG. 2, a spindle is provided as an adjusting device 8, while in FIG. 3, the adjusting device is a pneumatic cylinder 7. As for the rest, FIG. 3 corresponds to FIG. 2.

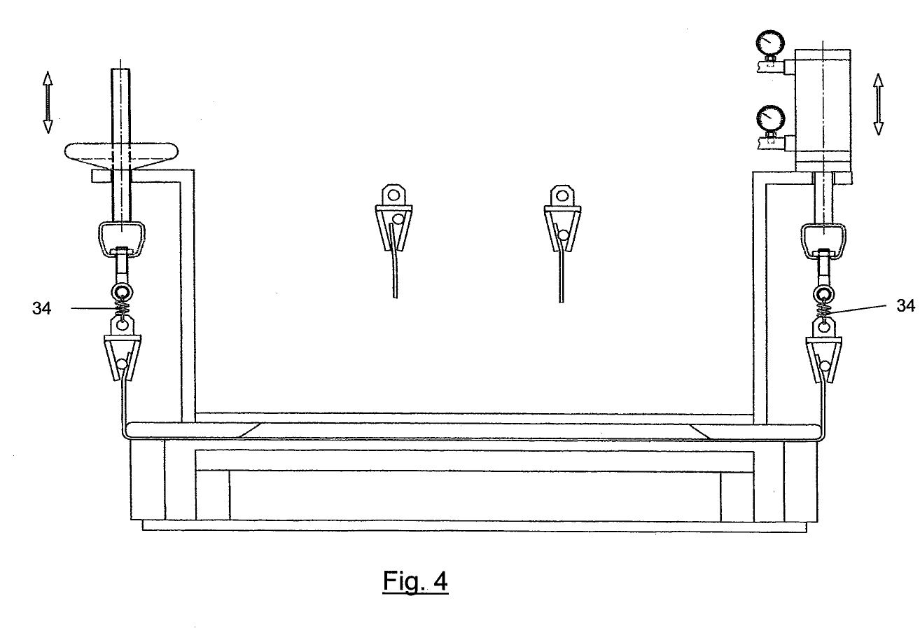

FIG. 4 shows the membrane press 1 of FIG. 1 wherein, contrary to FIG. 1, spring elements 34 are provided instead of the ring elements 19 between the eyelet 18 and the perforated tab 33, the spring elements 34 being preferably designed as coil springs. The spring elements 34 effect a compensation of forces between the holding elements 6 and the holding frame 2.

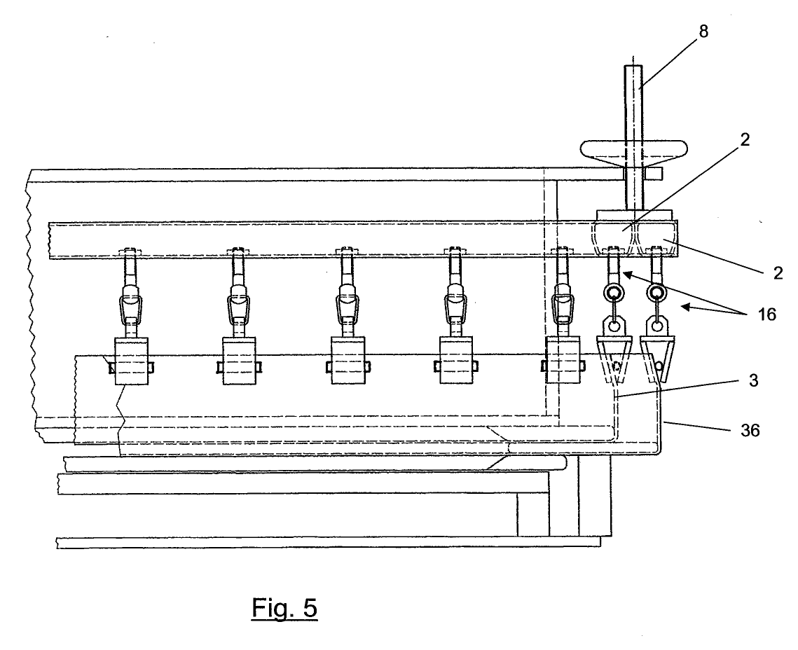

It is also possible to provide the membrane press 1 with a second membrane 36, resulting in a double membrane. Such an embodiment is shown in FIGS. 5 to 8.

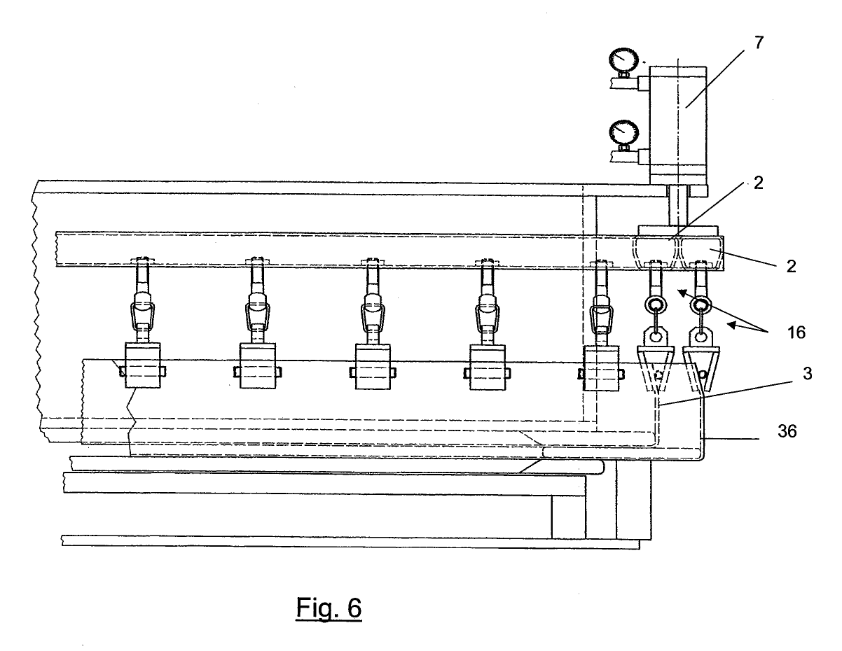

In the exemplary embodiment shown in FIGS. 5 and 6, the two membranes of the double membrane are each clamped in a row of holding elements, wherein the rows of holding elements are each separately assigned to the two membranes 3 and 36 and are each connected to a separately assigned holding frame 2 via the suspension elements 16. In addition, a common adjusting device 7 or 8 is assigned to the two separate holding frames 2.

In FIG. 5, the adjusting device 8 is designed as a spindle, wherein the adjusting device 7 shown in FIG. 6 is designed as a pneumatic cylinder. The particular adjusting device 7 or 8 simultaneously acts on both membranes 3, 36 or on the appropriate holding frame 2, so that the two membranes 3, 36 are tensioned and relaxed in common.

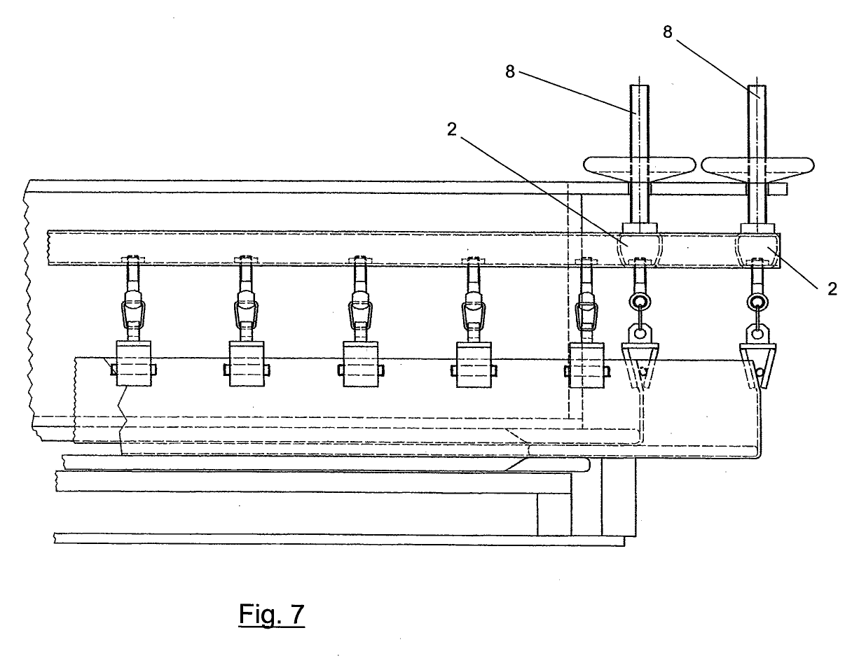

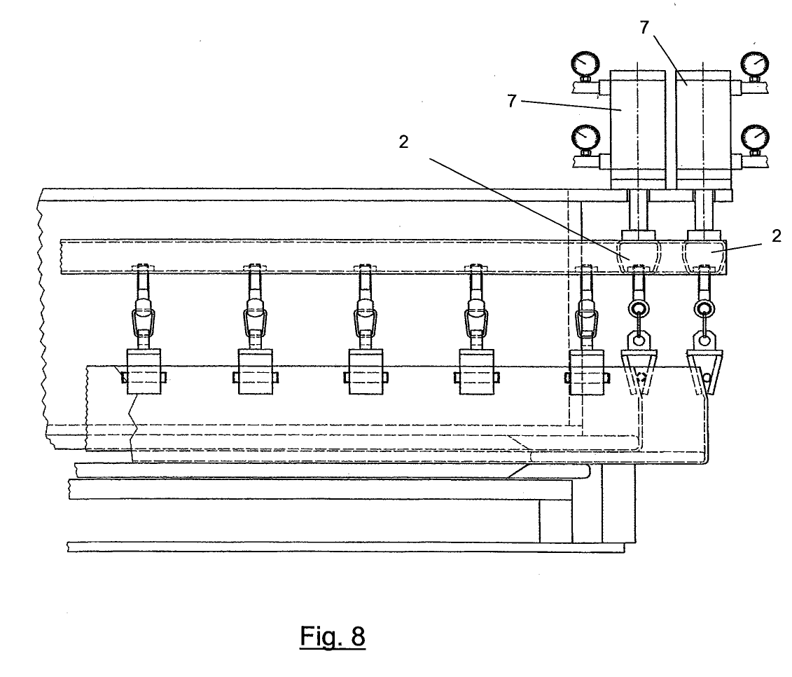

In the exemplary embodiment shown in FIGS. 7 and 8, a separate adjusting device 7, 8 is each assigned to the appropriate holding frame 2 here as well, wherein the adjusting device 7, 8 is accordingly designed as a spindle 8 (FIG. 7) or as a pneumatic cylinder 7 (FIG. 8). As a result, the particular holding frames 2 can also be separately adjusted in vertical direction, so that the two membranes 3, 36 can be tensioned separately.

It is also conceivable that, with their particular peripheral region 4, the two membranes 3 and 36 are each clamped in a common holding element 6 or a single row of holding elements in a force-locking manner so that, in this case, only one holding frame 2 is required.

To clamp the membrane 3 or 36 in the holding element(s) 6, the peripheral region 4 is inserted in the opening 27, with the clamping bolt 21 being lifted. This is shown by the holding element 6 being in the position indicated by reference number 32 (FIG. 1). Once the peripheral region 4 has been inserted to an appropriate extent, the clamping bolt is released, dropping in the clamping position 28. This is shown by the holding element 6 being in the position indicated by reference number 31 (FIG. 1). The clamping bolt 21 securely clamps the membrane 3 in a force-locking manner, wherein a self-clamping effect of the clamping bolt 21 is generated. Thus, the operator can easily connect the membrane 3 to the holding frame 2 via the holding elements 6 without using any additional tools. As a matter of course, the operator successively clamps the membrane 3 in all holding elements 6 of the row(s) of holding elements in a force-locking manner, wherein this can be achieved within a relatively short time because it is not necessary to use any tools or establish time-consuming screwed connections.

After the membrane 3 has been securely clamped, the adjusting devices 7 and 8 cause the holding frame 2 to be moved vertically (double arrow 9), so that the membrane 3 is tensioned along the clamping direction 9. This intensifies the self-clamping effect of the clamping bolt 21. Thus, the membrane 3 is securely held to an appropriate degree to be tensioned.

To disconnect the force-locking connection, the membrane 3 is relaxed by moving the holding frame 2 down in a vertical direction. The force-locking clamping connection is disconnected by lifting the clamping bolt(s) 21, so that the membrane 3 can be removed from the holding elements 6 one after the other. This is also achieved within a relatively short time since it is not necessary to disconnect any screwed connections nor to use any additional tools.

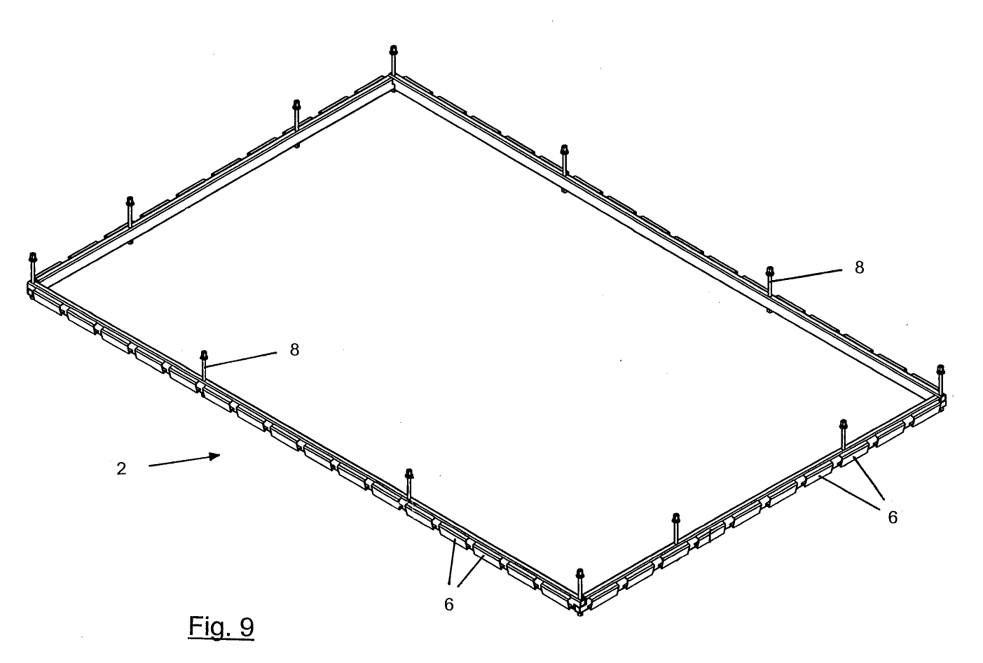

FIG. 9 is a perspective view of a holding frame 2 at a slanted angle from above, wherein the holding frame 2 forms a component part of a membrane press. Contrary to the exemplary embodiments described above, the holding frame 2 is provided with integrated holding elements 6. Basically, these holding elements 6 are, with regard to their function, designed in like manner as the holding elements 6 illustrated above by means of FIG. 1, wherein in the executive form according to FIG. 9, however, one of the clamping surfaces of the holding elements 6 is each directly formed by the outwardly directed surface of the holding frame 2 which is rectangular in its layout.

As is furthermore shown in FIG. 9, the holding elements 6 are, here, arranged such that they are spaced apart from each other at close intervals, whereby the membrane to be held (not shown here) can be secured in a clamping manner at a plurality of points along its membrane edge, practically without any appreciable interuptions.

Furthermore, the holding frame 2 according to FIG. 9 possesses adjusting devices 8 projecting from its upper side in an upward direction, the adjusting devices 8 being formed by threaded spindles which are used to adjust the holding frame 2 in a vertical direction and, thus, to tension and relax the membrane secured thereto.

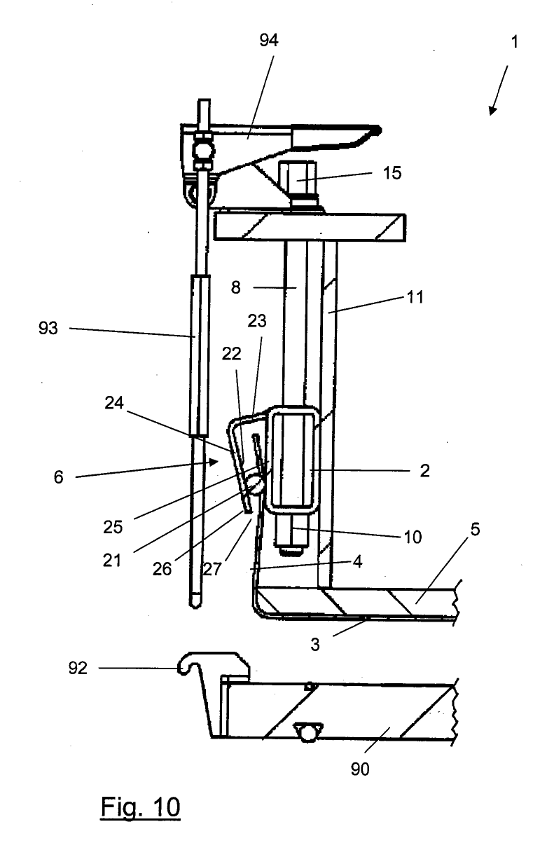

FIG. 10 is a cross-sectional view of the peripheral region of a membrane press which is provided with a holding frame 2 according to FIG. 9.

As can be clearly seen from the illustrated instance, the holding frame 2 is directly connected to the holding elements 6 only one of which is shown in this sectional view. In the illustrated instance, the holding element 6 is provided with a clamping web 24 extending such that it is spaced apart from a clamping surface 25 of the holding profile 2, the clamping surface 25 pointing to the outside, i.e. towards the clamping web 24. At its upper end, the clamping web 24 integrally changes into a transverse web 23 which, in turn, is connected, here welded, rigidly to the holding frame 2 with its end.

Here as well, a clamping bolt 21 the diameter of which is in excess of the clear passage size of the bottom opening 27 near the free lower end 26 of the clamping web 24, is arranged in the interior region of the space between the clamping web 24 on the one hand and the clamping surface 25 on the other hand, the space narrowing in downward direction in a cone-like manner. Here, the peripheral region 4 of the membrane 3 is secured in a clamping manner between the clamping surface 25 and the clamping bolt 21. Therein, the clamping bolt 21 is held in the clamping position by its own weight. Once a tractive force is exerted on the membrane 4, this clamping effect is further increased by a self-clamping effect.

The adjusting device 8 which is designed in the form of a threaded spindle is used to generate a clamping force for the membrane 3. Coming from above, the spindle-like adjusting device 8 extends through the holding profile 2. A threaded nut 10 is connected, appropriately welded, to the bottom side of the holding profile 2 in an anti-twist manner. A hexagon head 15, the diameter of which is such that, contrary to the spindle-like adjusting device 8, it does not fit through a plate-like rigid component 11 is attached in an anti-twist manner to the upper end of the adjusting device 8 which is positioned above the rigid component 11 of the membrane press 1. When this hexagon head 15 is turned, the spindle-like adjusting device 8 is also turned wherein, in cooperation with the threaded nut 10 and in relation to the direction of rotation, this results in an upward movement of the holding frame 2 or a downward movement of the holding frame 2 and, thus, in a tensioning or relaxing of the membrane 3.

The rear of the membrane 3, which points to the top in FIG. 10, is lined with a membrane support 5 in the form of a frame or plate.

According to FIG. 10, a sealing frame 90 is arranged below the membrane support 5 and the membrane 3 spaced apart therefrom. At the outer edge, that is to the left of the detail shown in FIG. 10, a plurality of hooks 92 are provided in the circumferential direction of the membrane press 1 such that they are spaced apart from each other, wherein the hooks 92 are each cooperating with a clamping rod 93, of which only one is visible. According to FIG. 10, the clamping rod 93 extends outside of, that is to the left of the holding profile 2 and the holding elements 6.

In a lowered position of the clamping rod 93, the latter's lower end can be brought in engagement with the associated hook 92. The clamping rod 93 is adjusted through a clamping lever 94 which is mounted to the rigid component 11 of the membrane press 1 and which can be swivelled from a released position to a clamped position (shown in the illustrated instance) and vice versa. To lower the clamping rod 93, the clamping lever 94 is swivelled by about 180 degrees or even further in counter-clockwise direction, whereby the lower end of the clamping rod 93 is lowered until it can be brought in engagement with the associated hook 92. By swiveling the clamping lever 94 in clockwise direction until it reaches the clamping position shown in FIG. 10, the clamping rod 93 is moved up, wherein the sealing frame 90 is carried along with the clamping rod 93 via the hook 92 and the sealing frame 90 is brought to bear against the bottom side of the membrane 3. In this position, the membrane 3 is clamped between the membrane support 5 and the sealing frame 90. For re-tensioning or replacing the membrane 3 the clamping is released by swiveling the clamping lever 94 into its release position.

The number of clamping rods 93 and clamping levers 94 distributed along the perimeter of the membrane press 1 depends on the size, in particular on the perimeter, of the membrane press 1 and the clamping forces to be applied. The greater the clamping forces to be applied, the higher the number of clamping rods 93 and clamping levers 94 appropriately used, wherein they are then also appropriately spaced apart from each other by a lesser distance.

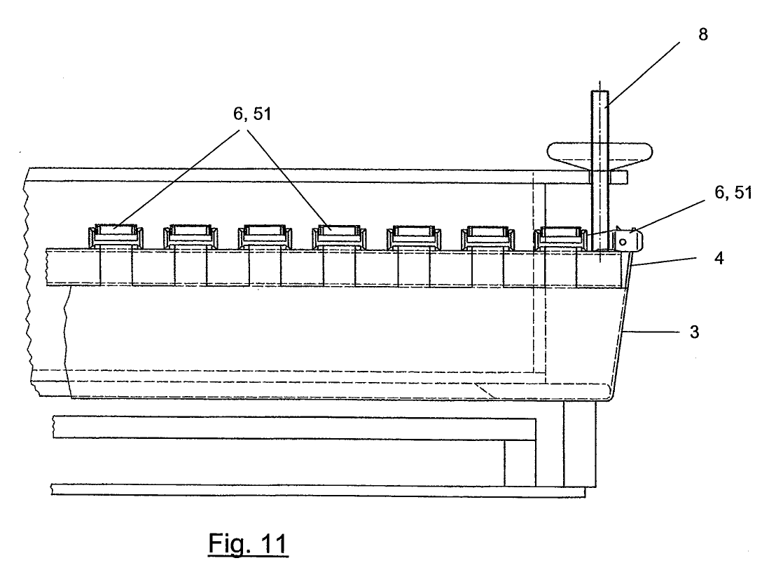

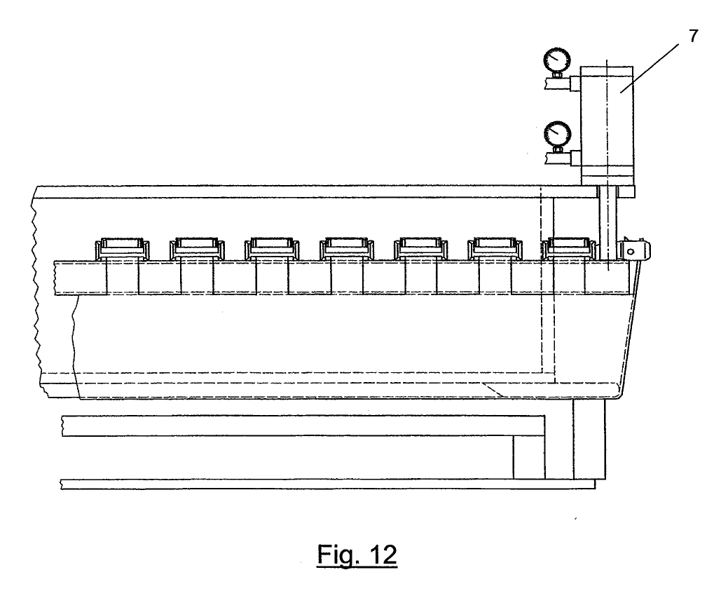

FIGS. 11 and 12 show a further executive form of the holding elements 6 which are designed in the form of a buckle in the illustrated instance. For example, the holding elements 6 can be designed in the form of a buckle lock 51. The holding elements 6 shown in FIGS. 11 and 12 can also be designed as a clamping lock or spring clip or sliding web lock or an eccentric lock or a belt clamp. The buckle locks 51 are arranged along the perimeter of the membrane 3 such that they are spaced apart from each other and are directly connected to the holding frame 2. In this advantageous embodiment of the holding elements 6 in the form of a buckle lock 51, it is appropriate that the membrane 3 is designed with teeth or indentations at its peripheral region 4, so that a force-locking connection to the buckle lock 51 can be established at each tooth or indentation of the peripheral region 4.

In essence, the exemplary embodiments shown in FIGS. 11 and 12 are identical wherein, again, only different adjusting devices 7 and 8 are shown. Therein, the adjusting device 8 shown in FIG. 11 is designed as a spindle, whereas the adjusting device 7 shown in FIG. 12 is designed as a pneumatic cylinder.

In FIGS. 1 to 12, the peripheral region 4 of the membrane 3 can be tensioned vertically in relation to a horizontal plane X (FIG. 1), this resulting in a clamping direction 9 accordingly extending in vertical direction.

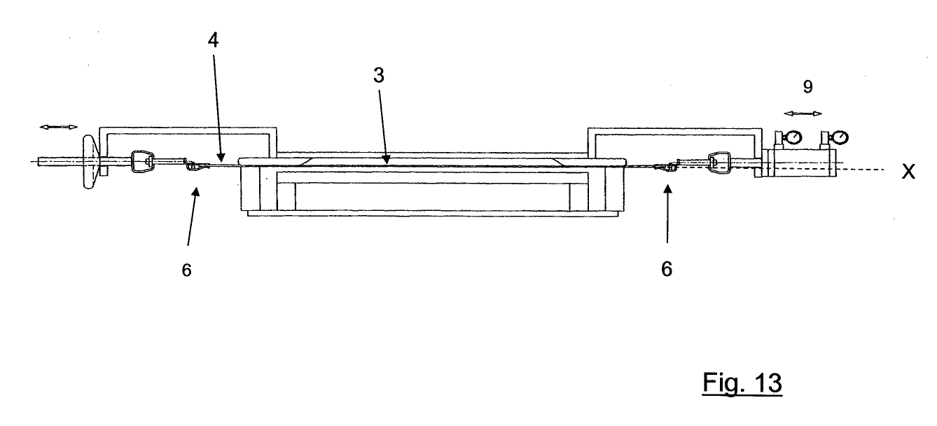

In contrast thereto, FIG. 13 shows a peripheral region 4 of the membrane 3, which can be tensioned in parallel to the horizontal plane X, this resulting in a clamping direction 9 accordingly extending in horizontal direction X. In the illustrated instance, the holding frame 2 is divided in at least four parts each of which is assigned to one side of the membrane press 3 and each of which can be adjusted in an outward direction, that is away from the membrane press 1, to tension the membrane 3.

All of the exemplary embodiments described above have in common that the membrane 3 can, at its peripheral region 4, be connected to and also removed from the holding frame 2 without any tools. To achieve this, an operator can actuate the holding elements successively, this resulting in saving time to a considerable extent. Furthermore, the membrane is secured in a gentle manner, so that it reaches a long service life.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim:

1. A membrane press for holding a membrane comprising:
at least one holding frame, wherein the membrane is, at its peripheral region, located on and removed from the holding frame by means of holding elements,
the holding elements comprising two clamping surfaces arranged in the manner of a claw,
a clamping bolt being assigned to the clamping surfaces so that the membrane is located in a force-locking manner, wherein the membrane is clamped between the clamping bolt and one of the clamping surfaces,
wherein the holding elements are configured such that the membrane is located thereon and removed therefrom without any tools.

2. A membrane press according to claim 1, wherein the holding elements comprise a transverse web with a clamping web arranged on either of its sides wherein, as seen in cross-section, the clamping webs are aligned such that they face away from the transverse web with their free end and extend in a direction towards each other at a slanted angle, with the result that an opening which increases in the direction of the transverse web in a cone-like manner, is formed opposite to the transverse web, wherein the clamping bolt is arranged in a clamping position near the free ends between the membrane and a locating surface positioned opposite to the clamping surface so that the membrane is located in a force-locking manner, and wherein the clamping bolt is liftable from the clamping position in the direction of the transverse web, with the result that the membrane is detached.

3. A membrane press according to claim 1, wherein the holding elements comprise a transverse web which, on one of its sides, is immediately and rigidly connected to the holding frame and at the other side of which a clamping web is arranged, wherein, as seen in cross-section, the clamping web is aligned such that it is facing away from the transverse web with its free end and is, at a slanted angle, extending in a direction towards a clamping surface of the holding frame that faces the clamping web, with the result that an opening which increases in the direction of the transverse web in a cone-like manner is formed opposite to the transverse web, wherein the clamping bolt is arranged in a clamping position near the free end between the membrane and a locating surface positioned opposite to the clamping surface so that the membrane is located in a force-locking manner, and wherein the clamping bolt is liftable from the clamping position in the direction of the transverse web, with the result that the membrane is detached.

4. A membrane press according to claim 1, wherein the holding elements engage the membrane while being distributed along the perimeter of the peripheral region.

5. A membrane press according to claim 1, wherein suspension elements arranged between the holding elements and the holding frame are assigned to the holding elements.

6. A membrane press according to claim 1, wherein spring elements arranged between the holding element and the holding frame are assigned to the holding elements.

7. A membrane press according to claim 1, wherein at least one adjusting device which can be used to adjust the holding frame in a clamping direction is assigned to the holding frame.

8. A membrane press according to claim 8, wherein the adjusting device is manually actuatable.

9. A membrane press according to claim 8, wherein the adjusting device comprises a power drive.

10. A membrane press according to claim 10, wherein the adjusting device comprises one of a hydraulic and pneumatic power drive.

11. A membrane press according to claim 10, wherein the adjusting device can be used to apply a predefinable tensile stress to the membrane so that the membrane can be re-tensioned continuously.

12. A membrane press according to claim 1, wherein the suspension elements are mounted such that they are movable in a longitudinal direction of the holding frame or along the holding frame.

13. A membrane press according to claim 1, wherein, with its peripheral region, the membrane can be tensioned vertically in relation to a horizontal plane (X).

14. A membrane press according to claim 1, wherein, with its peripheral region, the membrane is tensionable at an acute angle in relation to the horizontal plane (X).

15. A membrane press according to claim 1, wherein, with its peripheral region, the membrane can be tensioned in parallel to the horizontal plane (X) as seen in relation thereto.

16. A membrane press according to claim 1, wherein a membrane support in the form of one of a frame and a plate is arranged immediately above the membrane, a peripheral surrounding sealing frame is arranged below the membrane, the distance of the membrane support including membrane on the one hand in relation to the sealing frame on the other hand is adjustable, and the membrane support and the sealing frame are clampable against each other in a clamping position.

17. A membrane press according to claim 16, wherein a plurality of vertical clamping rods are provided to clamp the membrane support and the sealing frame against each other, wherein the clamping rods are arranged such that they are distributed along a perimeter of the membrane press, and wherein, with their lower end, they are detachably engagable with hooks provided on the sealing frame, and wherein they are adjustable in vertical direction by means of a clamping lever provided at each of their upper ends, and they are locatable in a clamping position.

18. A membrane press for holding a membrane comprising:
at least one holding frame, wherein the membrane is, at its peripheral region, located on and removed from the holding frame by means of holding elements,
the holding elements being configured such that the membrane is located thereon and removed therefrom without any tools,
the holding element being designed in a buckle-like manner in the form of one of a buckle lock, a clamping lock, a spring clip, a sliding web lock, an eccentric lock and a belt clamp.

19. A membrane press for holding a membrane comprising:
at least one holding frame including holding elements, wherein the membrane is, at its peripheral region, located on and removed from the holding frame by the holding elements,
the holding elements comprising two clamping surfaces arranged in the manner of a claw,
a clamping bolt arranged at the clamping surfaces, wherein the membrane is clamped between the clamping bolt and one of the clamping surfaces,
the holding elements being configured such that the membrane is located thereon and removed therefrom without any tools.
